(19) United States
(12) Patent Application Publication
(10) Pub. No.: US 2012/0170852 A1
(43) Pub. Date: Jul. 5, 2012

(54) FACE RECOGNITION APPARATUS AND METHODS

(76) Inventors: Wei Zhang, Fremont, CA (US); Tong Zhang, San Jose, CA (US)

(21) Appl. No.: 13/395,458

(22) PCT Filed: Sep. 25, 2009
(86) PCT No.: PCT/US09/58476

§ 371 Date: Mar. 12, 2012

(51) Int. Cl. G06K 9/48

(52) U.S. Cl. 382/197

(57) ABSTRACT

Interest regions are detected in respective images (18) having face regions labeled with respective facial part labels. For each of the detected interest regions, a respective facial region descriptor vector of facial region descriptor values characterizing the detected interest region is determined. Ones of the facial part labels are assigned to respective ones of the facial region descriptor vectors. For each of the facial part labels, a respective facial part detector (20) that detects facial region descriptor vectors corresponding to the facial part label is built. The facial part detectors (20) are associated with rules (30) that qualify segmentation results of the facial part detectors (20) based on spatial relations between interest regions detected in images and the respective face part labels assigned to the facial part detectors (20). Faces in images are detected and recognized based on application of the facial part detectors (20) to images.

### BACKGROUND

Face recognition techniques oftentimes are used to locate, identify, or verify one or more persons appearing in images in an image collection. In a typical face recognition approach, faces are detected in the images; the detected faces are normalized; features are extracted from the normalized faces; and the identities of persons appearing in the images are identified or verified based on comparisons of the extracted features with features that were extracted from faces in one or more query images or reference images. Many automatic face recognition techniques can achieve modest recognition accuracy rates with respect to frontal images of faces that are accurately registered. When applied to other facial views (poses) and to poorly registered or poorly illuminated facial images, however, these techniques typically fail to achieve acceptable recognition accuracy rates.

What are needed are systems and methods that are capable of detecting and recognizing face images with wide variations in scale, pose, illumination, expression, and occlusion.

### SUMMARY

In one aspect, the invention features a method in accordance with which interest regions are detected in respective images, which include respective face regions labeled with respective facial part labels. For each of the detected interest regions, a respective facial region descriptor vector of facial region descriptor values characterizing the detected interest region is determined. Ones of the facial part labels are assigned to respective ones of the facial region descriptor vectors determined for spatially corresponding ones of the face regions. For each of the facial part labels, a respective facial part detector that segments the facial region descriptor vectors that are assigned the facial part label from other ones of the facial region descriptor vectors is built. The facial part detectors are associated with rules that qualify segmentation results of the facial part detectors based on spatial relations between interest regions detected in images and the respective face part labels assigned to the facial part detectors.

In another aspect, the invention features a method in accordance with which interest regions are detected in an image. For each of the detected interest regions, a respective facial region descriptor vector of facial region descriptor values characterizing the detected interest region is determined. A first set of the detected interest regions are labeled with respective face part labels based on application of respective facial part detectors to the facial region descriptor vectors. Each of the facial part detectors segments the facial region descriptor vectors into members and nonmembers of a class corresponding to a respective one of multiple facial part labels. A second set of the detected interest regions is ascertained. In this process, one or more of the labeled interest regions are pruned from the first set based on rules that impose conditions on spatial relations between the labeled interest regions.

The invention also features apparatus operable to implement the methods described above and computer-readable media storing computer-readable instructions causing a computer to implement the methods described above.

### DESCRIPTION OF DRAWINGS

FIG. 1 is a block diagram of an embodiment of an image processing system.

FIG. 2 is a flow diagram of an embodiment of a method of building a face part detector.

FIG. 3A is a diagrammatic view of an exemplary set of face regions of an image labeled with respective face part labels in accordance with an embodiment of the invention.

FIG. 3B is a diagrammatic view of an exemplary set of face regions of an image labeled with respective face part labels in accordance with an embodiment of the invention.

FIG. 4 is a flow diagram of an embodiment of detecting face part regions in an image.

FIG. 5A is a diagrammatic view of an exemplary set of interest regions detected in an image.

FIG. 5B is a diagrammatic view of a subset of the interest regions detected in the image shown in FIG. 5A.

FIG. 6 is a flow diagram of an embodiment of a method of constructing a spatial pyramid representation of a face area in an image.

FIG. 7 is a diagrammatic view of a face area of an image partitioned into a set of different spatial bins in accordance with an embodiment of the invention.

FIG. 8 is a diagrammatic view of an embodiment of a process of matching a pair of images.

FIG. 9 is a diagrammatic view of an embodiment of an image processing system.

FIG. 10 is a block diagram of an embodiment of a computer system.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

As used herein, the term “includes” means includes but not limited to, the term “including” means including but not limited to. The term “based on” means based at least in part on. The term “ones” means multiple members of a specified group.

### II. FIRST EXEMPLARY EMBODIMENT OF AN IMAGE PROCESSING SYSTEM

The embodiments that are described herein provide systems and methods that are capable of detecting and recognizing face images with wide variations in scale, pose, illumination, expression, and occlusion.

A. Building a Face Recognition System

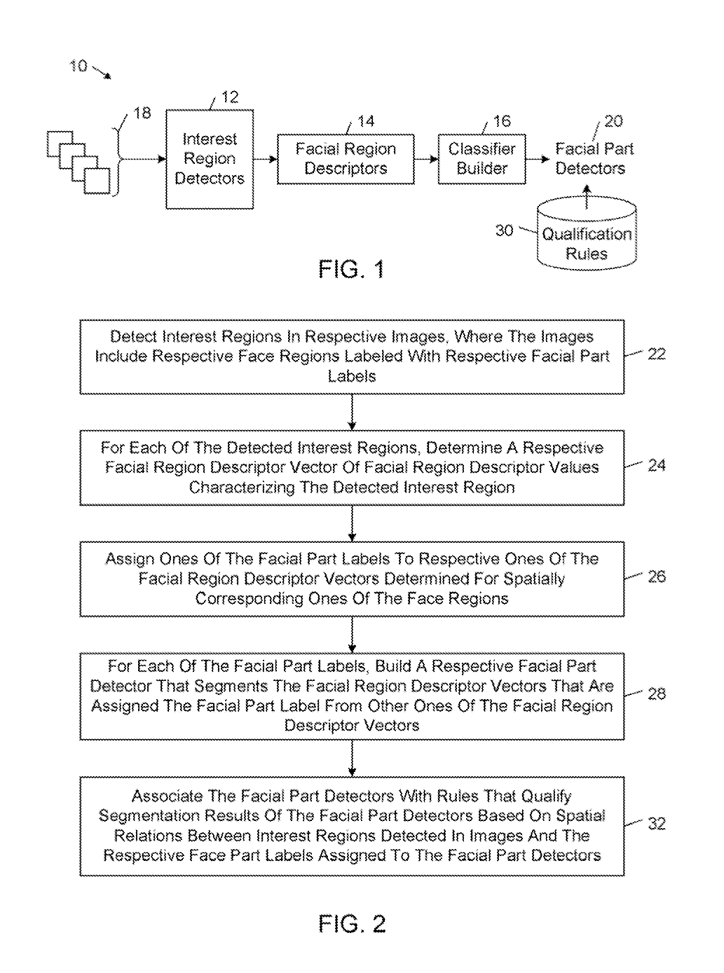

FIG. 1 shows an embodiment of an image processing system 10 that includes interest region detectors 12, facial region descriptors 14, and a classifier builder (or inducer) 16. In operation, the image processing system 10 processes a set of training images 18 to produce a set of facial part detectors 20 that are capable of detecting facial parts in images.

FIG. 2 shows an embodiment of a method by which the image processing system 10 builds the facial part detectors 20.

In accordance with the method of FIG. 2, the image processing system 10 applies the interest region detectors 12 to the training images 18 in order to detect interest regions in the training images 18 (FIG. 2, block 22). Each of the training images 18 typically has one or more manually labeled face regions demarcating respective facial parts fᵢ appearing in the training images 18. In general, any of a wide variety of different interest region detectors may be used to detect interest regions in the training images 18. In some embodiments, the interest region detector's 12 are affine-invariant interest region detectors (e.g., Harris corner detectors, Hessian blob detectors, principal curvature based region detectors, and salient region detectors).

For each of the detected interest regions, the image processing system 10 applies the facial region descriptors 14 to the detected interest region in order to determine a respective facial region descriptor vector \vec{V}_{R}=(d₁, . . . , dₙ) of facial region descriptor values characterizing the detected interest region (FIG. 2, block 24). In general, any of a wide variety of different local descriptors may be used to extract the facial region descriptor values, including distribution based descriptors, spatial-frequency based descriptors, differential descriptors, and generalized moment invariants. In some embodiments, the local descriptors 14 include a scale invariant feature transform (SIFT) descriptor and one or more textural descriptors (e.g., a local binary pattern (LBP) feature descriptor, and a Gabor feature descriptor).

The image processing system 10 assigns ones of the facial part labels in the training images 18 to respective ones of the facial region descriptor vectors that are determined for spatially corresponding ones of the face regions (FIG. 2, block 26). In this process, interest regions are assigned the labels that are associated with the face region that the interest regions overlap and each region descriptor vector \vec{V}_{R} inherits the label assigned to the associated interest region. When the center of an interest region is close to the boundaries of two manually labeled face regions or the interest region significantly overlaps two face regions, the interest region is assigned both facial part labels and the facial region descriptor vector associated with the interest region inherits both facial part labels.

For each of the facial part labels fᵢ, the classifier builder 16 builds (e.g., trains or induces) a respective one of the facial part detectors 20 that segments the facial region descriptor vectors \vec{V}_{R} that are assigned the facial part label fᵢ from other ones of the facial region descriptor vectors \vec{V}_{R} (FIG. 2, block 28). In this process, the facial region descriptor vectors \vec{V}_{R} that are assigned the facial part label fᵢ are used as the positive training samples Sᵢ⁺, and the other facial region descriptor vectors are used as the negative training samples Sᵢ⁻. The facial part detector 20 for facial part label fᵢ is trained to discriminate Sᵢ⁺; from Sᵢ⁻.

The image processing system 10 associates the facial part detectors 20 with the qualification rules 30, which qualify segmentation results of the facial part detectors 20 based on spatial relations between interest regions detected in images and the respective face part labels assigned to the facial part detectors 20 (FIG. 2, block 32). As explained below, the qualification rules 30 typically are manually coded rules that describe favored and disfavored conditions on labeling of respective groups of interest regions with respective ones of the face part labels in terms of spatial relations between the interest regions in the groups. The segmentation results of the facial part detectors 20 are scored based the qualification rules 30, and segmentation results that have lower scores are more likely to be discarded.

In some embodiments, the image processing system 10 additionally segments the facial region descriptor vectors that are determined for all the training images 18 into respective clusters. Each of the clusters consists of a respective subset of the facial region descriptor vectors and is labeled with a respective unique cluster label. In general, the facial region descriptor vectors may be segmented (or quantized) into clusters using any of a wide variety of vector quantization methods. In some embodiments, the facial region descriptor vectors are segmented as follows. After extracting a large number of facial region descriptor vectors from a set of training images 18, k-means or hierarchical clustering is used to group these vectors into M clusters (types or classes), where M has a specified integer value. The center (e.g., the centroid) of each cluster is called a “visual word”, and a list of the cluster centers forms a “visual codebook,” which is used to spatially match pairs of images, as described below. Each cluster is associated with a respective unique cluster label that constitutes the visual word. In the spatial matching process, each facial region descriptor vector that is determined for a pair of images (or image areas) to be matched is “quantized” by labeling it with the most similar (closest) visual word, and only the facial region descriptor vectors that are labeled with the same visual word are considered to be matches.

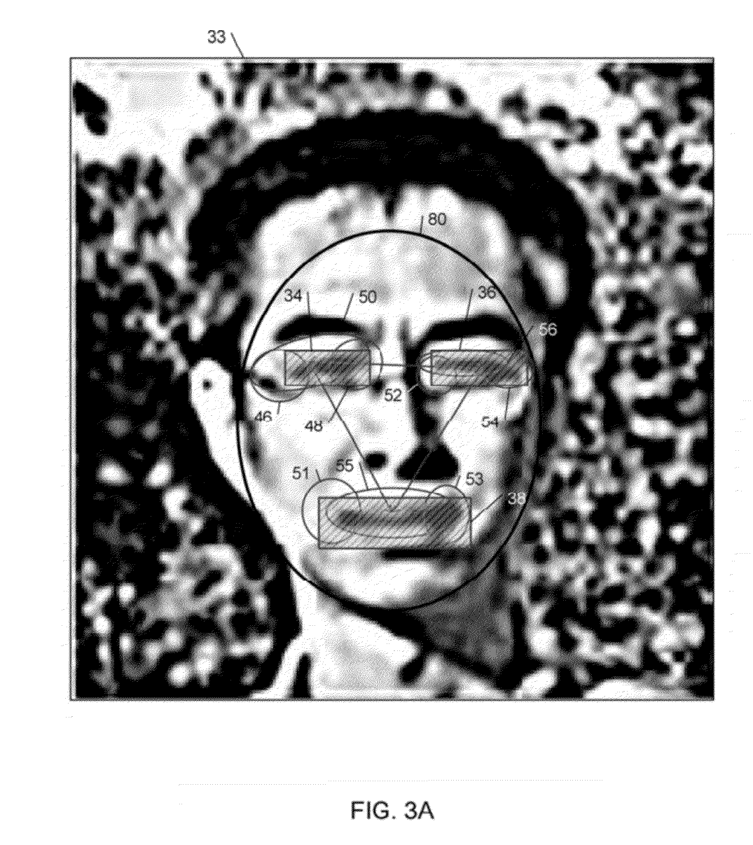

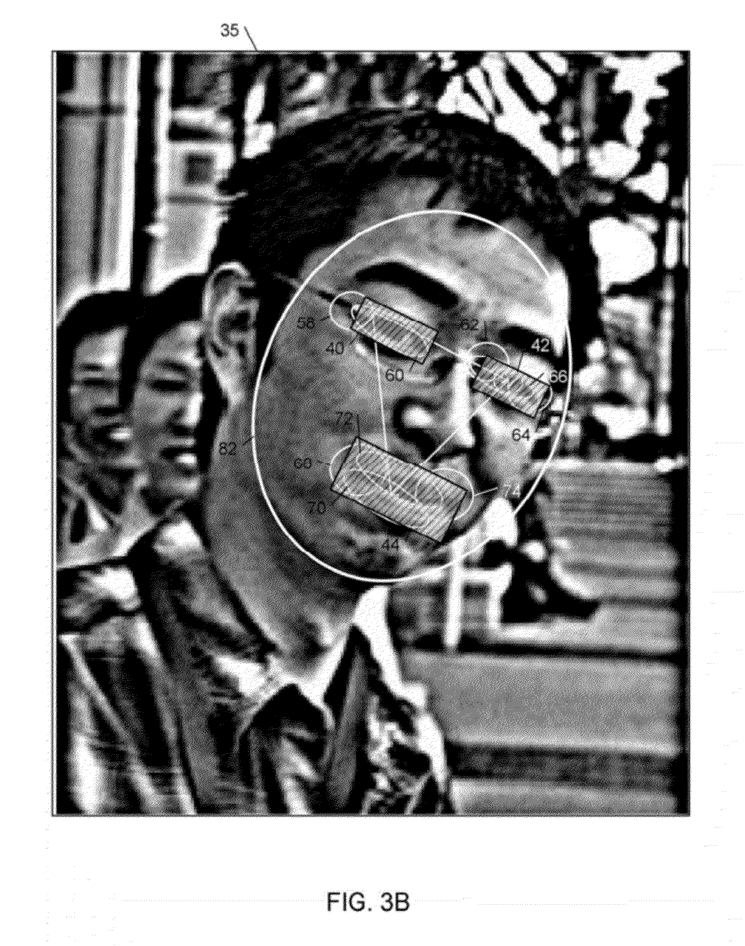

FIGS. 3A and 3B show examples of training images 33, 35. Each of the training images 33, 35 has one or more manually labeled rectangular face part regions 34, 36, 38, 40, 42, 44 demarcating respective facial parts (e.g., eyes, mouth, nose, etc.) appearing in the training images 33, 35. Each of the face part regions 34-44 is associated with a respective face part label (e.g., “eye” and “mouth”). The detected elliptical interest regions 46-74 are assigned the face part labels that are associated with the face part regions 34-44 with respect to which they have significant spatial overlap. For example, in the exemplary embodiment shown in FIG. 3A, the interest regions 46, 48, and 50 are assigned the face part label (e.g., “left eye”) that is associated with face part region 34; the interest regions 52, 54, and 56 are assigned the face part label (e.g., “right eye”) that is associated with face part region 36; and the interest regions 51, 53, and 55 are assigned the face part label (e.g., “mouth”) that is associated with face part region 38. In the exemplary embodiment shown in FIG. 3B, the interest regions 58 and 60 are assigned the face part label (e.g., “left eye”) that is associated with face part region 40; the interest regions 62, 64, and 66 are assigned the face part label (e.g., “right eye”) that is associated with face part region 42; and the interest regions 68, 70, 72, and 74 are assigned the face part label (e.g., “mouth”) that is associated with face part region 44.

In some embodiments, the image processing system 10 includes a face detector that provides a preliminary estimate of the location, size, and pose of the faces appearing in the training images 18. In general, the face detector may use any type of face detection process that determines the presence and location of each face in the training images 18. Exemplary face detection methods include but are not limited to feature-based face detection methods, template-matching face detection methods, neural-network-based face detection methods, and image-based face detection methods that train machine systems on a collection of labeled face samples. An exemplary feature-based face detection approach is described in Viola and Jones, “Robust Real-Time Object Detection,” Second International Workshop of Statistical and Computation theories of Vision—Modeling, Learning, Computing, and Sampling, Vancouver, Canada (Jul. 13, 2001). An exemplary neural-network-based face detection method is described in Rowley et al., “Neural Network-Based Face Detection,” IEEE Transactions on Pattern Analysis and Machine Intelligence, Vol. 20, No. 1 (January 1998).

The face detector outputs one or more face region parameter values, including the locations of the face areas, the sizes (i.e., the dimensions) of the face areas, and the rough poses (orientations) of the face areas. In the exemplary embodiments shown in FIGS. 3A and 3B, the face areas are demarcated by respective elliptical boundaries 80, 82 that define the locations, sizes, and poses of the face areas appearing in the images 33, 35. The poses of the face areas are given by the orientation of the major and minor axes of the ellipses, which are usually obtained by locally refining the originally detected circular or rectangular face areas.

The image processing system 10 normalizes the locations and sizes (or scales) of the detected interest regions based on the face region parameter values so that the qualification rules 30 can be applied to the segmentation results of the facial part detectors 20. For example, the qualification rules 30 typically describe conditions on labeling of respective groups of interest regions with respective ones of the face part labels in terms of spatial relations between the interest regions in the groups. In some embodiments, the spatial relations model the relative angle and distance between face parts or the distance between face parts and the centroid of the face. The qualification rules 30 typically describe the most likely spatial relations between the major face parts, such as eyes, nose, mouth, cheeks. One exemplary qualification rule promotes segmentation results in which, on a normalized face, the right eye is most likely to be found displaced from the left eye along a line at a 0° angle (horizontal) at a distance of half the face area width. Another exemplary qualification rule reduces the likelihood of segmentation results in which a labeled eye region overlaps with a labeled mouth region.

B. Recognizing Faces in Images

The image processing system 10 uses the facial part detectors 20 and the qualification rules in the process of recognizing faces in images.

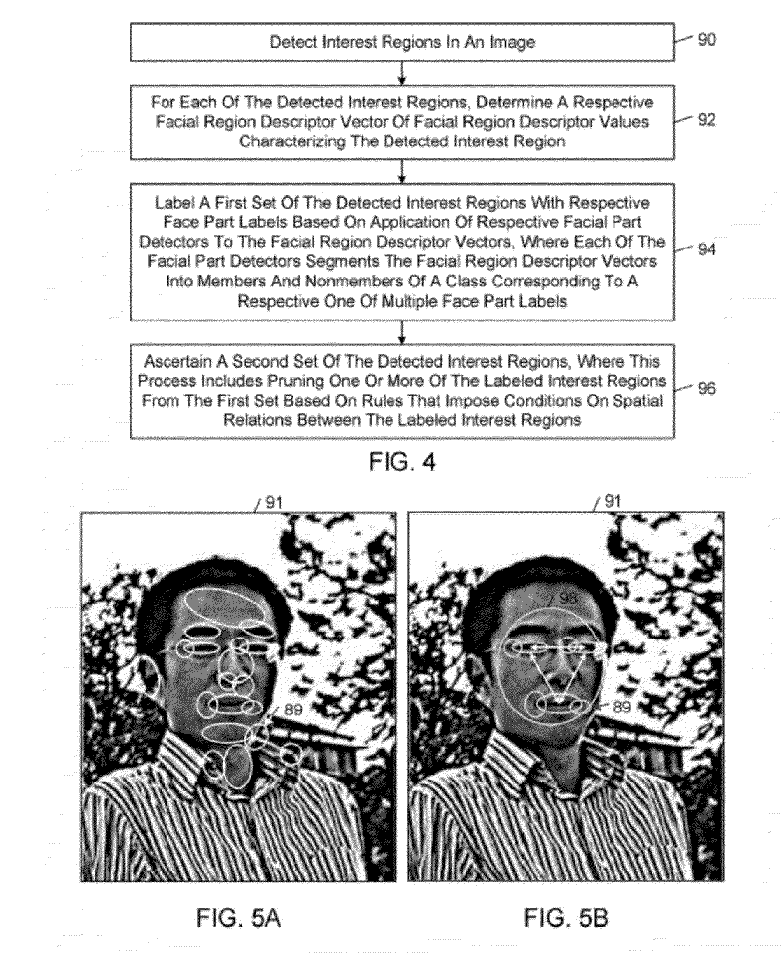

FIG. 4 shows an embodiment by which the image processing system 10 detects face parts in an image.

In accordance with the embodiment of FIG. 4, the image processing system 10 detects interest regions in the image (FIG. 4, block 90). In this process, the image processing system 10 applies the interest region detectors 12 to the image in order to detect interest regions in the image. FIG. 5A shows an exemplary set of elliptical interest regions 89 that are detected in an image 91.

For each of the detected interest regions, the image processing system 10 determines a respective facial region descriptor vector of facial region descriptor values characterizing the detected interest region (FIG. 4, block 92). In this process, the image processing system 10 applies the facial region descriptors 14 to each of the detected interest regions in order to determine a respective facial region descriptor vector \vec{V}_{R}=(d₁, . . . , dₙ) of facial region descriptor values characterizing the detected interest region.

The image processing system 10 labels a first set of the detected interest regions with respective face part labels based on application of respective ones of the facial part detectors 20 to the facial region descriptor vectors (FIG. 4, block 94). Each of the facial part detectors 20 segments the facial region descriptor vectors into members and nonmembers of a class corresponding to a respective one of the facial part labels that are associated with the facial part detectors 20. The classification decision is soft with a prediction confidence value. An exemplary classifier with real-valued confidence value is Support Vector Machine described in Christopher, J. C. B. “A tutorial on support vector machines for pattern recognition,” Data Mining and Knowledge Discovery, volume 2(2), pages 121-167 (1998).

The image processing system 10 ascertains a second set of the detected interest regions (FIG. 4, block 96). In this process, the image processing system 10 prunes one or more of the labeled interest regions from the first set based on the qualification rules 30, which impose conditions on spatial relations between the labeled interest regions.

In some embodiments, the image processing system 10 applies a robust matching algorithm to the first set of classified facial region descriptor vectors in order to further prune and refine facial region descriptor vectors based on the classification of the interest regions corresponding to the labeled facial region descriptor vectors. The matching algorithm is an extension of a Hough Transform process that incorporates the face-specific domain knowledge encoded in the qualification rules 30. In this process, each instantiation of a group of the facial region descriptor vectors at the corresponding detected interest regions vote for a possible location, scale and pose of the face area. The confidence of voting is decided by two measures: (a) confidence values associated with the classification results produced by the facial part detectors; and (b) the consistency of the spatial configuration of the classified facial region descriptor vectors with the qualification rules 30. For example, a facial region descriptor vector labeled as a mouth is not likely to be collinear with a pair of facial region descriptor vectors labeled as eyes, thus, the vote for this group of labeled facial region descriptor vectors will have near-zero confidence no matter how confident the detectors are.

The image processing system 10 obtains a final estimation of the location, scale and pose of the face area based on the spatial locations of the group of labeled facial region descriptor vectors that have the dominant vote. In this process, the image processing system 10 determines the location, scale and pose of the face area based on a face area model that takes as inputs the spatial locations particular ones of the labeled facial region descriptor vectors (e.g., the locations of the centroids of facial region descriptor vectors respectively classified as left eye, a right eye, a mouth, lips, a cheek, and/or a nose). In this process, the image processing system 10 aligns (or registers) the face area so that the person's face can be recognized. For each detected face area, the image processing system 10 aligns the extracted features in relation to a respective face area demarcated by a face area boundary that encompasses some or all portions of the detected face area. In some embodiments, the face area boundary corresponds to an ellipse that includes the eyes, nose, mouth but not the entire forehead or chin or top of head of a detected face. Other embodiments may use face area boundaries of different shapes (e.g., rectangular).

The image processing system 10 further prunes the classification of the facial region descriptor vectors based on the final estimation of the location, scale and pose of the face area. In this process, the image processing system 10 discards any of the labeled facial region descriptor vectors that are inconsistent with a model of the locations of face parts in a normalized face area that corresponds to the final estimate of the face area. For example, the image processing system 10 discards interest regions that are labeled as eyes that are located in the lower half of the normalized face area. If no face part label is assigned to a facial region descriptor vector after the pruning process, that facial region descriptor vector is designated as being “missing.” In this way, the detection process can handle the recognition of occluded faces. The output of the pruning process includes “cleaned” facial region descriptor vectors that are associated with interest regions that are aligned (e.g., labeled consistently) with corresponding face parts in the image, and parameters that define the final estimated location, scale, and pose of the face area. FIG. 58 shows the cleaned set of elliptical interest regions 89 that are detected in the image 91 and a face area boundary 98 that demarcates the final estimated location, scale, and pose of the face area. The final estimation of the location, scale and pose of the face area is expected to be much more accurate than the original area detected by the face detectors.

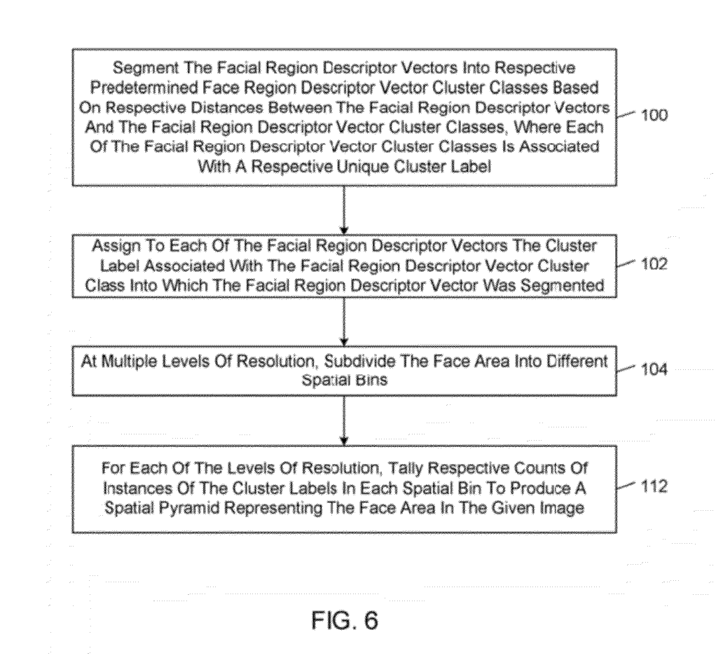

FIG. 6 shows an embodiment of a method by which the image processing system 10 constructs from the cleaned facial region descriptor vectors and the final estimate of the face area a spatial pyramid that represents a face area that is detected in an image.

In accordance with the method of FIG. 6, the image processing system 10 segments (or quantizes) the facial region descriptor vectors into respective ones of the predetermined face region descriptor vector cluster classes (FIG. 6, block 100). As explained above, each of these clusters is associated with a respective unique cluster label. The segmentation process is based on the respective distances between the facial region descriptor vectors and the facial region descriptor vector cluster classes. In general, a wide variety of vector difference measures may be used to determine the distances between the facial region descriptor vectors and the cluster classes. In some embodiments, the distances correspond to a vector norm (e.g., the L2-norm) between the facial region descriptor vectors and the centroids of the facial region descriptor vectors in the clusters. Each of the facial region descriptor vectors is segmented into the closest (i.e., shortest distance) one of the cluster classes.

The image processing system 10 assigns to each of the facial region descriptor vectors the cluster label that is associated with the facial region descriptor vector cluster class into which the facial region descriptor vector was segmented (FIG. 6, block 102).

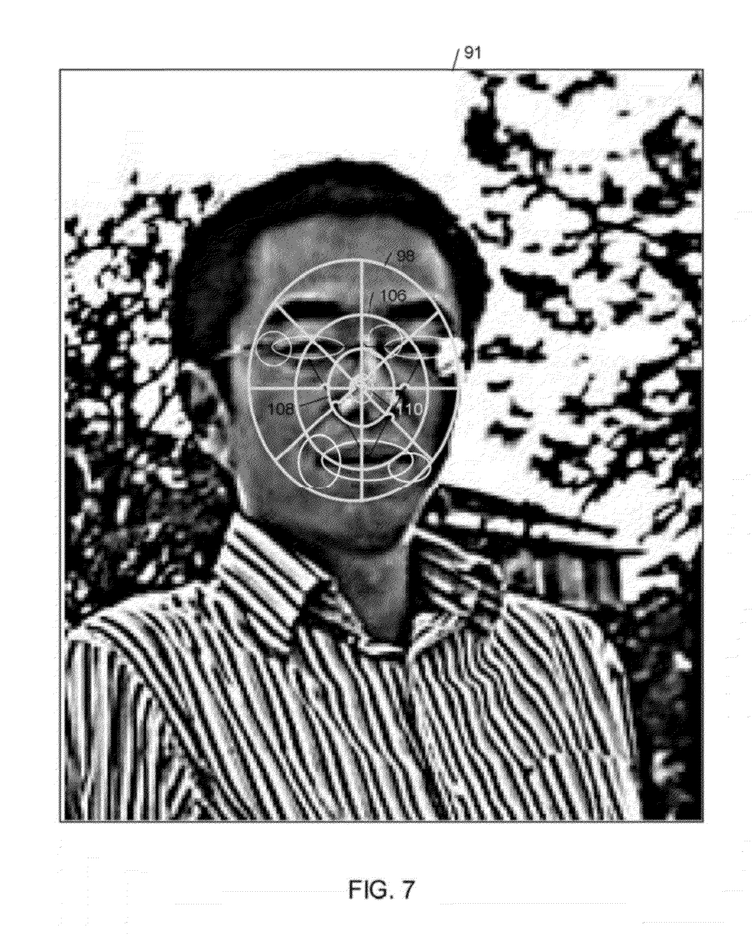

At multiple levels of resolution, the image processing system 10 subdivides the face area into different spatial bins (FIG. 6, block 104). In some embodiments, the image processing system 10 subdivides the face area into log-polar spatial bins. FIG. 7 shows an exemplary embodiment of image 91 in which the face region, which is demarcated by the face region boundary 98, is divided into a set of log-polar bins at four different resolution levels, each corresponding to a different set of the elliptical boundaries 98, 106, 108, 110. In other embodiments, the image processing system 10 subdivides the face area into rectangular spatial bins.

For each of the levels of resolution, the image processing system 10 tallies respective counts of instances of the cluster labels in each spatial bin to produce a spatial pyramid representing the face area in the given image (FIG. 6, block 112). In other words, for each cluster label, the image processing system 10 counts the facial region descriptor vectors that fall in each spatial bin to produce a respective spatial pyramid histogram.

The image processing system 10 is operable to recognize a person's face in the given image based on comparisons of the spatial pyramid with one or more predetermined spatial pyramids generated from one or more known images containing the person's face. In this process, the image processing system constructs a pyramid match kernel that corresponds to a weighted sum of histogram intersections between the spatial pyramid representation of the face in the given image and the spatial pyramid determined for another image. A histogram match occurs when facial descriptor vectors of the same cluster class (i.e., have the same cluster label) are located in the same spatial bin. The weight that is applied to the histogram intersections typically increases with increasing resolution level (i.e., decreasing spatial bin size). In some embodiments, the image processing system 10 compares the spatial pyramids using a pyramid match kernel of the type described in S. Lazebnik, C. Schmid, J. Ponce, “Beyond bags of features: spatial pyramid matching for recognizing natural scene categories,” IEEE Conference on Computer Vision and Pattern Recognition 2006.

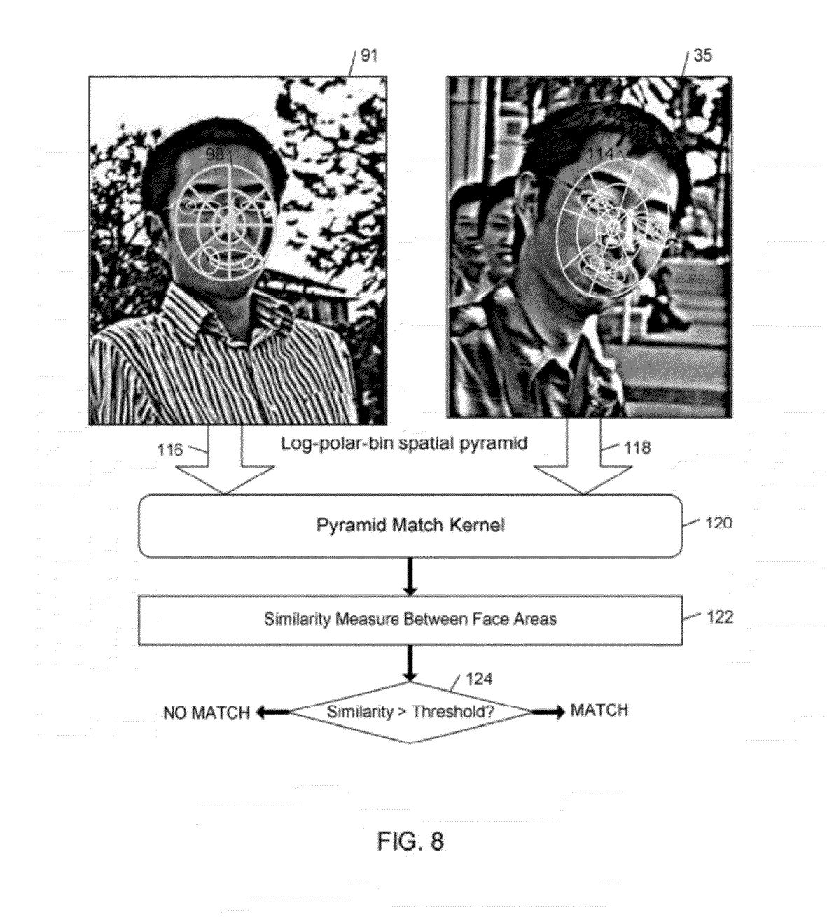

FIG. 8 shows an embodiment of a process by which the image processing system 10 matches two face areas 98, 114 that appear in a pair of images 91, 35. The image processing system 10 subdivides the face areas 98, 114 into different spatial bins as described above in connection with block 104 of FIG. 6. Next, the image processing system 10 determines spatial pyramid representations 116, 118 of the face areas 98, 35 as described above in connection with block 112 of FIG. 6. The image processing system 10 calculates a pyramid match kernel 120 from the weighted sum of intersections between the spatial pyramid representations 116, 118. The calculated value of the pyramid match kernel 120 corresponds to measure 122 of similarity between the faces areas 98, 114. In some embodiments, the image processing system 10 determines whether or not a pair of face areas match (i.e., are images of the same person) by applying a threshold to the similarity measure 122 and declares a match when the similarity measure 122 exceeds the threshold (FIG. 8, block 124).

### III. SECOND EXEMPLARY EMBODIMENT OF AN IMAGE PROCESSING SYSTEM

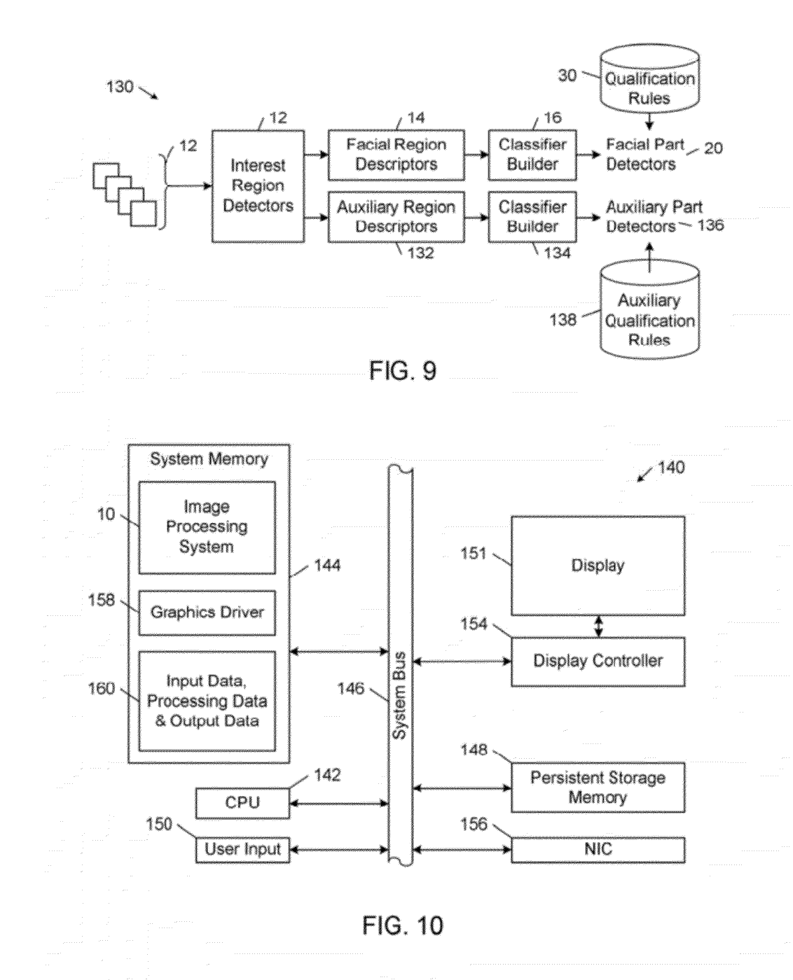

FIG. 9 shows an embodiment 130 of the image processing system 10 that includes the interest region detectors 12, the facial region detectors 14, and the classifier builder 16. The image processing system 130 additionally includes auxiliary region detectors 132, and an optional second classifier builder 136

In operation, the image processing system 130 processes the training images 18 to produce the facial part detectors 20 that are capable of detecting facial parts in images as described above in connection with the image processing system 10. The image processing system 130 also applies the auxiliary region descriptors to the detected interest regions to determine a set of auxiliary region descriptor vectors 132 and builds the set of auxiliary region detectors 136 from the auxiliary region descriptor vectors. The process of applying the auxiliary region descriptors 132 and building the auxiliary part detectors 136 is essentially the same as the process by which the image processing system 10 applies the facial region descriptors 14 and builds the facial part detectors 20; the primary difference being the nature of the auxiliary region descriptors 132, which are tailored to represent patterns typically found in contextual regions, such as eyebrows, ears, forehead, chin, and neck, which do not tend to change much over time and different occasions.

In these embodiments, the image processing system 130 applies the interest region detectors 12 to the training images 18 in order to detect interest regions in the training images 18 (see FIG. 2, block 22). Each of the training images 18 typically has one or more manually labeled face regions demarcating respective facial parts fᵢ appearing in the training images 18 and one or more manually labeled auxiliary regions demarcating respective auxiliary parts aᵢ appearing in the training images 18. In general, any of a wide variety of different interest region detectors may be used to detect interest regions in the training images 18. In some embodiments, the interest region detectors 12 are affine-invariant interest region detectors (e.g., Harris corner detectors, Hessian blob detectors, principal curvature based region detectors, and salient region detectors).

For each of the detected interest regions, the image processing system 130 applies the facial region descriptors 14 to the detected interest region in order to determine a respective facial region descriptor vector \vec{V}_{FR}=(d₁, . . . , dₙ) of facial region descriptor values characterizing the detected interest region (see FIG. 2, block 24). The image processing system 130 also applies the auxiliary (or contextual) region descriptors 14 to each of the detected interest region in order to determine a respective auxiliary region descriptor vector \vec{V}_{AR}=c₁, . . . , cₙ) of auxiliary region descriptor values characterizing the detected interest region. In general, any of a wide variety of different local descriptors may be used to extract the facial region descriptor values and the auxiliary region descriptor values, including distribution based descriptors, spatial-frequency based descriptors, differential descriptors, and generalized moment invariants. In some embodiments, the auxiliary and facial descriptors 132, 14 include a scale invariant feature transform (SIFT) descriptor and one or more textural descriptors (e.g., a local binary pattern (LBP) feature descriptor, and a Gabor feature descriptor). The auxiliary descriptors also include shape-based descriptors. An exemplary type of shape-based descriptor is a shape context descriptor that describes a distribution over relative positions of the coordinates on an auxiliary region shape using a coarse histogram of the coordinates of the points on the shape relative to a given point on the shape. Addition details of the shape context descriptor are described in Belongie, S., Malik, J. and Puzicha, J., “Shape matching and object recognition using shape contexts,” In IEEE Transactions on Pattern Analysis and Machine Intelligence, volume 24(4), pages 509-522 (2002).

The image processing system 130 assigns ones of the facial part labels in the training images 18 to respective ones of the facial region descriptor vectors that are determined for spatially corresponding ones of the face regions (see FIG. 2, block 26). The image processing system 130 also assigns ones of the auxiliary part labels in the training images 18 to respective ones of the auxiliary region descriptor vectors that are determined for spatially corresponding ones of the auxiliary regions. In this process, interest regions are assigned the labels that are associated with the auxiliary region that the interest regions overlap and each auxiliary region descriptor vector \vec{V}_{AR} inherits the label assigned to the associated interest region. When the center of an interest region is close to the boundaries of two manually labeled auxiliary regions or the interest region significantly overlaps two auxiliary regions, the interest region is assigned both auxiliary part labels and the auxiliary region descriptor vector associated with the interest region inherits both auxiliary part labels.

For each of the facial part labels fᵢ, the classifier builder 16 builds (e.g., trains or induces) a respective one of the facial part detectors 20 that segments the facial region descriptor vectors \vec{V}_{FR} that are assigned the facial part label fᵢ from other ones of the facial region descriptor vectors \vec{V}_{FR} (see FIG. 2, block 28). For each of the auxiliary part labels aᵢ, the classifier builder 134 builds (e.g., trains or induces) a respective one of the auxiliary part detectors 136 that segments the auxiliary region descriptor vectors \vec{V}_{AR} that are assigned the auxiliary part label a; from other ones of the auxiliary region descriptor vectors \vec{V}_{AR}. In this process, the auxiliary region descriptor vectors \vec{V}_{AR} that are assigned the auxiliary part label aᵢ are used as the positive training samples Tᵢ⁺, and the other auxiliary region descriptor vectors are used as the negative training samples Tᵢ⁻. The auxiliary part detector 136 for auxiliary part label a; is trained to discriminate Tᵢ⁺ from Tᵢ⁻.

The image processing system 130 associates the facial part detectors 20 with the qualification rules 30, which qualify segmentation results of the facial part detectors 20 based on spatial relations between interest regions detected in images and the respective face part labels assigned to the facial part detectors 20 (see FIG. 2, block 32). The image processing system 130 also associates the auxiliary part detectors 136 with auxiliary part qualification rules 138, which qualify segmentation results of the auxiliary part detectors 136 based on spatial relations between interest regions detected in images and the respective auxiliary part labels assigned to the auxiliary part detectors 136. The auxiliary part qualification rules 138 typically are manually coded rules that describe favored and disfavored conditions on labeling of respective groups of interest regions with respective ones of the auxiliary part labels in terms of spatial relations between the interest regions in the groups. The segmentation results of the auxiliary part detectors 136 are scored based the auxiliary part qualification rules 138, and segmentation results that have lower scores are more likely to be discarded in a manner analogous to the process described above in connection with the face part qualification rules 30.

In some embodiments, the image processing system 130 additionally segments the auxiliary region descriptor vectors that are determined for all the training images 18 into respective clusters. Each of the clusters consists of a respective subset of the auxiliary region descriptor vectors and is labeled with a respective unique cluster label. In general, the auxiliary region descriptor vectors may be segmented (or quantized) into clusters using any of a wide variety of vector quantization methods. In some embodiments, the auxiliary region descriptor vectors are segmented as follows. After extracting a large number of auxiliary region descriptor vectors from a set of training images 18, k-means or hierarchical clustering is used to group these vectors into K clusters (types or classes), where K has a specified integer value. The center (e.g., the centroid) of each cluster is called a “visual word”, and a list of the cluster centers forms a “visual codebook”, which is used to spatially matching pairs of images, as described above. Each cluster is associated with a respective unique cluster label that constitutes the visual word. In the spatial matching process, each auxiliary region descriptor vector that is determined for a pair of images (or image areas) to be matched is “quantized” by labeling it with the most similar (closest) visual word, and only the auxiliary region descriptor vectors that are labeled with the same visual word are considered to be matches in the spatial pyramid matching process described above.

The image processing system 130 seamlessly integrates the auxiliary part detectors 136 and the auxiliary part qualification rules 138 into the face recognition process described above in connection with the image processing system 10. The integrated face recognition process uses the auxiliary part detectors 136 to classify auxiliary region descriptor vectors that are determined for each image, prunes the set of auxiliary region descriptor vectors using the auxiliary part qualification rules 138, performs vector quantization on the cleaned set of auxiliary region descriptor vectors to build a visual codebook of auxiliary regions, and performs spatial pyramid matching on the visual codebook representation of the auxiliary region descriptor vectors in respective ways that are directly analogous to the corresponding ways described above in which the image processing system 10 recognizes faces using the facial part detectors 20 and the qualification rules 30.

### IV. EXEMPLARY OPERATING ENVIRONMENT

Each of the training images 18 (see FIG. 1) may correspond to any type of image, including an original image (e.g., a video keyframe, a still image, or a scanned image) that was captured by an image sensor (e.g., a digital video camera, a digital still image camera, or an optical scanner) or a processed (e.g., sub-sampled, filtered, reformatted, enhanced or otherwise modified) version of such an original image.

Embodiments of the image processing systems 10 (including image processing system 130) may be implemented by one or more discrete modules (or data processing components) that are not limited to any particular hardware, firmware, or software configuration. In the illustrated embodiments, these modules may be implemented in any computing or data processing environment, including in digital electronic circuitry (e.g., an application-specific integrated circuit, such as a digital signal processor (DSP)) or in computer hardware, firmware, device driver, or software. In some embodiments, the functionalities of the modules are combined into a single data processing component. In some embodiments, the respective functionalities of each of one or more of the modules are performed by a respective set of multiple data processing components.

The modules of the image processing systems 10, 130 may be co-located on a single apparatus or they may be distributed across multiple apparatus; if distributed across multiple apparatus, these modules and the display 24 may communicate with each other over local wired or wireless connections, or they may communicate over global network connections (e.g., communications over the Internet).

In some implementations, process instructions (e.g., machine-readable code, such as computer software) for implementing the methods that are executed by the embodiments of the image processing systems 10, 130, as well as the data they generate, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, embodiments of the image processing systems 10, 130 may be implemented in any one of a wide variety of electronic devices, including desktop computers, workstation computers, and server computers.

FIG. 10 shows an embodiment of a computer system 140 that can implement any of the embodiments of the image processing system 10 (including image processing system 130) that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 10, the system memory 144 also stores the image processing system 10, a graphics driver 158, and processing information 160 that includes input data, processing data, and output data. In some embodiments, the image processing system 10 interfaces with the graphics driver 158 (e.g., via a DirectX® component of a Microsoft Windows® operating system) to present a user interface on the display 151 for managing and controlling the operation of the image processing system 10.

### V. CONCLUSION

The embodiments that are described herein provide systems and methods that are capable of detecting and recognizing face images with wide variations in scale, pose, illumination, expression, and occlusion.

Other embodiments are within the scope of the claims.

1. A method, comprising:
detecting interest regions in respective images (18), wherein the images (18) comprise respective face regions labeled with respective facial part labels;
for each of the detected interest regions, determining a respective facial region descriptor vector of facial region descriptor values characterizing the detected interest region;
assigning ones of the facial part labels to respective ones of the facial region descriptor vectors determined for spatially corresponding ones of the face regions;
for each of the facial part labels, building a respective facial part detector (20) that segments the facial region descriptor vectors that are assigned the facial part label from other ones of the facial region descriptor vectors; and
associating the facial part detectors (20) with rules (30) that qualify segmentation results of the facial part detectors (20) based on spatial relations between interest regions detected in images and the respective face part labels assigned to the facial part detectors (20);
wherein the determining, the assigning, the building, and the associating are performed by a computer (140).

2. The method of claim 1, wherein at least one of the rules (30) describes a condition on labeling of a given group of interest regions with respective ones of the face part labels in terms of a spatial relation between the interest regions in the given group.

3. The method of claim 1, wherein the images (18) comprise respective auxiliary regions that are outside the face regions and are labeled with respective auxiliary part labels, and further comprising:
for each of the detected interest regions, determining a respective auxiliary region descriptor vector of region descriptor values characterizing the detected interest region;
assigning ones of the auxiliary part labels to respective ones of the auxiliary region descriptor vectors determined for spatially corresponding ones of the auxiliary regions;
for each of the auxiliary part labels, building a respective auxiliary part detector (136) that segments the auxiliary region descriptor vectors (136) that are assigned the auxiliary part label from other ones of the auxiliary region descriptor vectors (136); and
associating the auxiliary part detectors (136) with rules (138) that qualify segmentation results of the auxiliary part detectors (136) based on spatial relations between interest regions detected in images and the respective auxiliary part labels assigned to the auxiliary part detectors (136).

4. The method of claim 3, further comprising:
labeling interest regions detected in a given image with respective ones of the face part labels and the auxiliary part labels based on application of the facial part detectors (20) to respective facial region descriptor vectors determined for the labeled interest regions and further based on application of the auxiliary part detectors (136) to respective auxiliary region descriptor vectors determined for the interest regions;
ascertaining a face area (98, 114) in the given image (91, 35) based on the labeled interest regions;
at multiple levels of resolution, subdividing the face area (98, 114) into different spatial bins;
for each of the levels of resolution, tallying respective counts of instances of the face part labels in each spatial bin; and
constructing from the tallied counts a spatial pyramid representation (116, 118) of the face area (98, 114) in the given image (91, 35).

5. The method of claim 1, wherein the determining comprises: applying facial region descriptors (14) to the detected interest regions to produce a first set of facial region descriptor vectors of facial region descriptor values characterizing the detected interest regions; and segmenting the first set of facial region descriptor vectors into clusters, wherein each of the clusters consists of a respective subset of the first set of facial region descriptor vectors and is labeled with a respective unique cluster label.

6. A method, comprising:
detecting interest regions (89) in an image (91);
for each of the detected interest regions (89), determining a respective facial region descriptor vector of facial region descriptor values characterizing the detected interest region (89);
labeling a first set of the detected interest regions (89) with respective face part labels based on application of respective facial part detectors (20) to the facial region descriptor vectors, wherein each of the facial part detectors (20) segments the facial region descriptor vectors into members and nonmembers of a class corresponding to a respective one of multiple face part labels; and
ascertaining a second set of the detected interest regions, wherein the ascertaining comprises pruning one or more of the labeled interest regions from the first set based on rules (30) that impose conditions on spatial relations between the labeled interest regions;
wherein the detecting, the determining, the labeling, and the ascertaining are performed by a computer (140).

7. The method of claim 6, wherein at least one of the rules (30) describes a condition on the labeling of a given group of interest regions (89) with respective ones of the face part labels in terms of a spatial relation between the interest regions (89) in the group.

8. The method of claim 7, further comprising identifying respective groups of the labeled interest regions (89) that satisfy the rules (30), and determining parameter values specifying location, scale, and pose defining a face area (98) in the image (91) based on locations of the labeled interest regions (89) in the identified groups.

9. The method of claim 8, further comprising segmenting the facial region descriptor vectors into respective predetermined face region descriptor vector cluster classes based on respective distances between the facial region descriptor vectors and the facial region descriptor vector cluster classes, wherein each of the facial region descriptor vector cluster classes is associated with a respective unique cluster label, and each of the facial region descriptor vectors is assigned the cluster label associated with the facial region descriptor vector cluster class into which the facial region descriptor vector was segmented.

10. The method of claim 9, further comprising:
at multiple levels of resolution, subdividing the face area (98) into different spatial bins; and
for each of the levels of resolution, tallying respective counts of instances of the unique cluster labels in each spatial bin to produce a spatial pyramid (116) representing the face area (98) in the given image (91).

11. The method of claim 10, further comprising recognizing a person's face in the image (89) based on comparisons of the spatial pyramid (116) with one or more predetermined spatial pyramids (118) generated from other images (35).

12. The method of claim 6, further comprising:
for each of the detected interest regions (89), determining a respective auxiliary region descriptor vector of auxiliary region descriptor values characterizing the detected interest region (89);
labeling a third set of the detected interest regions (89) with respective auxiliary part labels based on application of respective auxiliary part detectors (136) to the auxiliary region descriptor vectors, wherein each of the auxiliary part detectors (136) segments the auxiliary region descriptor vectors into members and nonmembers of a class corresponding to a respective one of the auxiliary part labels;
ascertaining a fourth set of the detected interest regions (89), wherein the ascertaining of the fourth set comprises pruning one or more of the labeled interest regions from the third set based on rules (138) that impose conditions on spatial relations between the labeled interest regions in the third set.

13. Apparatus, comprising:
a computer-readable medium (144, 148) storing computer-readable instructions; and
a processor (142) coupled to the computer-readable medium (144, 148), operable to execute the instructions, and based at least in part on the execution of the instructions operable to perform operations comprising
detecting interest regions in respective images (18), wherein the images (18) comprise respective face regions labeled with respective facial part labels,
for each of the detected interest regions, determining a respective facial region descriptor vector of facial region descriptor values characterizing the detected interest region,
assigning ones of the facial part labels to respective ones of the facial region descriptor vectors determined for spatially corresponding ones of the face regions,
for each of the facial part labels, building a respective facial part detector (20) that segments the facial region descriptor vectors that are assigned the facial part label from other ones of the facial region descriptor vectors, and
associating the facial part detectors (20) with rules (30) that qualify segmentation results of the facial part detectors based on spatial relations between interest regions detected in images and the respective face part labels assigned to the facial part detectors.

14. The apparatus of claim 13, wherein at least one of the rules (30) describes a condition on labeling of a given group of interest regions with respective ones of the face part labels in terms of a spatial relation between the interest regions in the given group.

15. The apparatus of claim 13, wherein in the determining the processor (142) is operable to perform operations comprising: applying facial region descriptors to the detected interest regions to produce a first set of facial region descriptor vectors of facial region descriptor values characterizing the detected interest regions; and segmenting the first set of facial region descriptor vectors into clusters, wherein each of the clusters consists of a respective subset of the first set of facial region descriptor vectors and is labeled with a respective unique cluster label.

16. At least one computer-readable medium (144, 148) having computer-readable program code embodied therein, the computer-readable program code adapted to be executed by a computer (140) to implement a method comprising:
detecting interest regions in respective images (18), wherein the images (18) comprise respective face regions labeled with respective facial part labels;
for each of the detected interest regions, determining a respective facial region descriptor vector of facial region descriptor values characterizing the detected interest region;
assigning ones of the facial part labels to respective ones of the facial region descriptor vectors determined for spatially corresponding ones of the face regions;
for each of the facial part labels, building a respective facial part detector (20) that segments the facial region descriptor vectors that are assigned the facial part label from other ones of the facial region descriptor vectors; and
associating the facial part detectors (20) with rules (30) that qualify segmentation results of the facial part detectors (20) based on spatial relations between interest regions detected in images and the respective face part labels assigned to the facial part detectors (20).

17. The at least one computer-readable medium of claim 16, wherein at least one of the rules (30) describes a condition on labeling of a given group of interest regions with respective ones of the face part labels in terms of a spatial relation between the interest regions in the given group.

18. The at least one computer-readable medium of claim 16, wherein the determining comprises: applying facial region descriptors to the detected interest regions to produce a first set of facial region descriptor vectors of facial region descriptor values characterizing the detected interest regions; and segmenting the first set of facial region descriptor vectors into clusters, wherein each of the clusters consists of a respective subset of the first set of facial region descriptor vectors and is labeled with a respective unique cluster label.

19. Apparatus, comprising:
a computer-readable medium (144, 148) storing computer-readable instructions; and
a processor (142) coupled to the computer-readable medium (144, 148), operable to execute the instructions, and based at least in part on the execution of the instructions operable to perform operations comprising
detecting interest regions (89) in an image (91);
for each of the detected interest regions (89), determining a respective facial region descriptor vector of facial region descriptor values characterizing the detected interest region;
labeling a first set of the detected interest regions (89) with respective face part labels based on application of respective facial part detectors (20) to the facial region descriptor vectors, wherein each of the facial part detectors (20) segments the facial region descriptor vectors into members and nonmembers of a class corresponding to a respective one of multiple face part labels; and
ascertaining a second set of the detected interest regions (89), wherein the ascertaining comprises pruning one or more of the labeled interest regions (89) from the first set based on rules (30) that impose conditions on spatial relations between the labeled interest regions (89).

20. At least one computer-readable medium (144, 148) having computer-readable program code embodied therein, the computer-readable program code adapted to be executed by a computer (142) to implement a method comprising:
detecting interest regions (89) in an image (91);
for each of the detected interest regions (89), determining a respective facial region descriptor vector of facial region descriptor values characterizing the detected interest region;
labeling a first set of the detected interest regions (89) with respective face part labels based on application of respective facial part detectors (20) to the facial region descriptor vectors, wherein each of the facial part detectors (20) segments the facial region descriptor vectors into members and nonmembers of a class corresponding to a respective one of multiple face part labels; and
ascertaining a second set of the detected interest regions (89), wherein the ascertaining comprises pruning one or more of the labeled interest regions (89) from the first set based on rules (30) that impose conditions on spatial relations between the labeled interest regions (89).
